(19) United States
(12) Patent Application Publication
(10) Pub. No.: US 2015/0324234 A1
(43) Pub. Date: Nov. 12, 2015

(54) TASK SCHEDULING METHOD AND RELATED NON-TRANSITORY COMPUTER READABLE MEDIUM FOR DISPATCHING TASK IN MULTI-CORE PROCESSOR SYSTEM BASED AT LEAST PARTLY ON DISTRIBUTION OF TASKS SHARING SAME DATA AND/OR ACCESSING SAME MEMORY ADDRESS(ES)

(71) Applicant: MEDIATEK INC., Hsin-Chu (TW)

(72) Inventors: Ya-Ting Chang, Hsinchu City (TW); Jia-Ming Chen, Hsinchu County (TW); Yu-Ming Lin, Taipei City (TW); Tzu-Jen Lo, New Taipei City (TW); Tung-Feng Yang, New Taipei City (TW); Yin Chen, Taipei City (TW); Hung-Lin Chou, Hsinchu County (TW)

(21) Appl. No.: 14/650,862

(22) PCT Filed: Nov. 14, 2014
(86) PCT No.: PCT/CN2014/091086

§ 371 Date: Jun. 9, 2015

Related U.S. Application Data
(60) Provisional application No. 61/904,072, filed on Nov. 14, 2013.

(51) Int. Cl. G06F 9/50

(52) U.S. Cl. CPC G06F 9/5016

(57) ABSTRACT

A task scheduling method for a multi-core processor system includes at least the following steps: when a first task belongs to a thread group currently in the multi-core processor system, where the thread group has a plurality of tasks sharing same specific data and/or accessing same specific memory address(es), and the tasks comprise the first task and at least one second task, determining a target processor core in the multi-core processor system based at least partly on distribution of the at least one second task in at least one run queue of at least one processor core in the multi-core processor system, and dispatching the first task to a run queue of the target processor core.

### CROSS REFERENCE TO RELATED APPLICATIONS

This application claims the benefit of U.S. provisional application No. 61/904,072, filed on Nov. 14, 2013 and incorporated herein by reference.

### TECHNICAL FIELD

The disclosed embodiments of the present invention relate to a task scheduling scheme, and more particularly, to a task scheduling method for dispatching a task (e.g., a normal task) in a multi-core processor system based at least partly on distribution of tasks sharing the same specific data and/or accessing the same specific memory address(es) and a related non-transitory computer readable medium.

### BACKGROUND

A multi-core system becomes popular nowadays due to increasing need of computing power. Hence, an operating system (OS) of the multi-core system may need to decide task scheduling for different processor cores to maintain good load balance and/or high system resource utilization. The processor cores may be categorized into different clusters, and the clusters may be assigned with separated caches at the same level in a cache hierarchy, respectively. For example, different clusters may be configured to use different level-2 (L2) caches, respectively. In general, a cache coherent interconnect may be implemented in the multi-core system to manage cache coherency between caches dedicated to different clusters. However, the cache coherent interconnect has coherency overhead when L2 cache read miss or L2 cache write occurs. The convention task scheduling design simply finds a busiest processor core, and moves a task from a run queue of the busiest processor core to a run queue of an idlest processor core. As a result, the convention task scheduling design controls the task migration from one cluster to another cluster without considering the cache coherence overhead.

Thus, there is a need for an innovative task scheduling design that is aware of the cache coherence overhead when dispatching a task to a run queue in a cluster, thus mitigating or avoiding the cache coherence overhead to achieve improved task scheduling performance.

### SUMMARY

In accordance with exemplary embodiments of the present invention, a task scheduling method for dispatching a task (e.g., a normal task) in a multi-core processor system based at least partly on distribution of tasks sharing the same specific data and/or accessing the same specific memory address(es) and a related non-transitory computer readable medium are proposed to solve the above-mentioned problem.

According to a first aspect of the present invention, an exemplary task scheduling method for a multi-core processor system is disclosed. The exemplary task scheduling method includes: when a first task belongs to a thread group currently in the multi-core processor system, where the thread group has a plurality of tasks sharing same specific data, and the tasks comprise the first task and at least one second task, determining a target processor core in the multi-core processor system based at least partly on distribution of the at least one second task in at least one run queue of at least one processor core in the multi-core processor system, and dispatching the first task to a run queue of the target processor core.

According to a second aspect of the present invention, an exemplary task scheduling method for a multi-core processor system is disclosed. The exemplary task scheduling method includes: when a first task belongs to a thread group currently in the multi-core processor system, where the thread group has a plurality of tasks accessing same specific memory address(es), and the tasks comprise the first task and at least one second task, determining a target processor core in the multi-core processor system based at least partly on distribution of the at least one second task in at least one run queue of at least one processor core in the multi-core processor system, and dispatching the first task to a run queue of the target processor core.

In addition, a non-transitory computer readable medium storing a task scheduling program code is also provided, wherein when executed by a multi-core processor system, the task scheduling program code causes the multi-core processor system to perform any of the aforementioned task scheduling methods.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram illustrating a multi-core processor system according to an embodiment of the present invention.

FIG. 2 is a diagram illustrating a non-transitory computer readable medium according to an embodiment of the present invention.

FIG. 3 is a diagram illustrating a first task scheduling operation which dispatches one task that is a single-threaded process to a run queue of a processor core.

FIG. 4 is a diagram illustrating a second task scheduling operation which dispatches one task that belongs to a thread group to a run queue of a processor core.

FIG. 5 is a diagram illustrating a third task scheduling operation which dispatches one task that belongs to a thread group to a run queue of a processor core.

FIG. 6 is a diagram illustrating a fourth task scheduling operation which dispatches one task that belongs to a thread group to a run queue of a processor core.

FIG. 7 is a diagram illustrating a fifth task scheduling operation which dispatches one task that belongs to a thread group to a run queue of a processor core.

FIG. 8 is a diagram illustrating a sixth task scheduling operation which makes one task that belongs to a thread group migrate from a run queue of a processor core in one cluster to a run queue of a processor core in another cluster.

FIG. 9 is a diagram illustrating a seventh task scheduling operation which makes one task that is a single-threaded process migrate from a run queue of a processor core in one cluster to a run queue of a processor core in another cluster.

FIG. 10 is a diagram illustrating an eighth task scheduling operation which makes one task that is a single-threaded process migrate from a run queue of a processor core in one cluster to a run queue of a processor core in another cluster.

FIG. 11 is a diagram illustrating a ninth task scheduling operation which makes one task that is a single-threaded process migrate from a run queue of a processor core in a cluster to a run queue of a processor in the same cluster.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

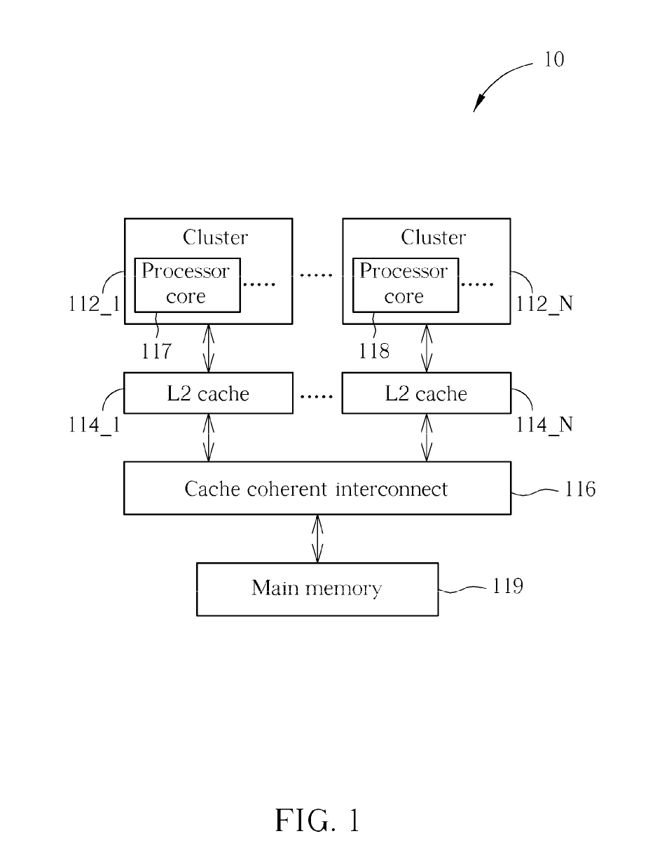

FIG. 1 is a diagram illustrating a multi-core processor system according to an embodiment of the present invention. The multi-core processor system 10 may be implemented in a portable device, such as a mobile phone, a tablet, a wearable device, etc. However, this is not meant to be a limitation of the present invention. That is, any electronic device using the proposed task scheduling method falls within the scope of the present invention. In this embodiment, the multi-core processor system 10 may have a plurality of clusters 112_1-112_N, where N is a positive integer and may be adjusted based on actual design consideration. That is, the present invention has no limitation on the number of clusters implemented in the multi-core processor system 10.

Regarding the clusters 112_1-112_N, each cluster may be a group of processor cores. For example, the cluster 112_1 may include one or more processor cores 117, each having the same processor architecture with the same computing power; and the cluster 112_N may include one or more processor cores 118, each having the same processor architecture with the same computing power. In one example, the processor cores 117 may have different processor architectures with different computing power. In another example, the processor cores 118 may have different processor architectures with different computing power. In one exemplary design, the proposed task scheduling method may be employed by the multi-core processor system 10 with symmetric multi-processing (SMP) architecture. Hence, each of the processor cores in the multi-core processor system 10 may have the same processor architecture with the same computing power. In another exemplary design, the proposed task scheduling method may be employed by the multi-core processor system 10 with heterogeneous multi-core architecture. For example, each processor core 117 of the cluster 112_1 may have first processor architecture with first computing power, and each processor core 118 of the cluster 112_N may have second processor architecture with second computing power, where the second processor architecture may be different from the first processor architecture, and the second computing power may be different from the first computing power.

It should be noted that, the processor core numbers of the clusters 112_1-112_N may be adjusted based on the actual design consideration. For example, the number of processor cores 117 included in the cluster 112_1 may be identical to or different from the number of processor cores 118 included in the cluster 112_N.

The clusters 112_1-112_N may be configured to use a plurality of separated caches at the same level in cache hierarchy, respectively. In this example, one dedicated L2 cache may be assigned to each cluster. As shown in FIG. 1, the multi-core processor system 10 may have a plurality of L2 caches 114_1-114_N. Hence, the cluster 112_1 may use one L2 cache 114_1 for caching data, and the cluster 112_N may use another L2 cache 114_N for caching data. In addition, a cache coherent interconnect 116 may be used to manage coherency between the L2 caches 114_1-114_N individually accessed by the clusters 112_1-112_N. As shown in FIG. 1, there is a main memory 119 coupled to the L2 caches 114_1-114_N via the cache coherent interconnect 116. When a cache miss of an L2 cache occurs, the requested data may be retrieved from the main memory 119 and then stored into the L2 cache. When a cache hit of an L2 cache occurs, this means that the requested data is available in the L2 cache, such that there is no need to access the main memory 119.

The same data in the main memory 119 may be stored at the same memory addresses. In addition, a cache entry in each of L2 caches 114_1-114_N may be accessed based on a memory address included in a read/write request issued from a processor core. The proposed task scheduling method may be employed for increasing a cache hit rate of an L2 cache dedicated to a cluster by assigning multiple tasks sharing the same specific data in the main memory 119 and/or accessing the same specific memory address(es) in the main memory 119 to the same cluster. For example, when one task running on one processor core of the cluster first issues a read/write request for a requested data at a memory address, a cache miss of the L2 cache may occur, and the requested data at the memory address may be retrieved from the main memory 119 and then cached in the L2 cache. Next, when another task running on one processor core of the same cluster issues a read/write request for the same requested data at the same memory address, a cache hit of the L2 cache may occur, and the L2 cache can directly output the requested data cached therein in response to the read/write request without accessing the main memory 119. When tasks sharing the same specific data in the main memory 119 and/or accessing the same specific memory address(es) in the main memory 119 are dispatched to the same cluster, the cache hit rate of the L2 cache dedicated to the cluster can be increased. Since cache coherence overhead can be caused by a cache miss (read/write miss) that triggers cache coherence, the increased cache hit rate can help reduce cache coherence overhead. Hence, in the present invention, a thread group may be defined as having a plurality of tasks sharing same specific data, for example, in the main memory 119 and/or accessing same specific memory address(es), for example, in the main memory 119. A task can be a single-threaded process or a thread of a multi-threaded process. When most or all of the tasks belonging to the same thread group are scheduled to be executed on the same cluster, the cache coherence overhead caused by cache read/write miss may be mitigated or avoided due to improved cache locality.

Based on above observation, the proposed task scheduling method may be aware of the cache coherence overhead when controlling one task to migrate from one cluster to another cluster. Thus, the proposed task scheduling method may be a thread group aware task scheduling scheme which checks characteristics of a thread group when dispatching a task of the thread group to one of the clusters.

It should be noted that the term “multi-core processor system” may mean a multi-core system or a multi-processor system, depending upon the actual design. In other words, the proposed task scheduling method may be employed by any of the multi-core system and the multi-processor system. For example, concerning the multi-core system, all of the processor cores 117 may be disposed in one processor. For another example, concerning the multi-processor system, each of the processor cores 117 may be disposed in one processor. Hence, each of the clusters 112_1-112_N may be a group of processors. For example, the cluster 112_1 may include one or more processors sharing the same L2 cache 114_1, and the cluster 112_N may include one or more processors sharing the same L2 cache 114_N.

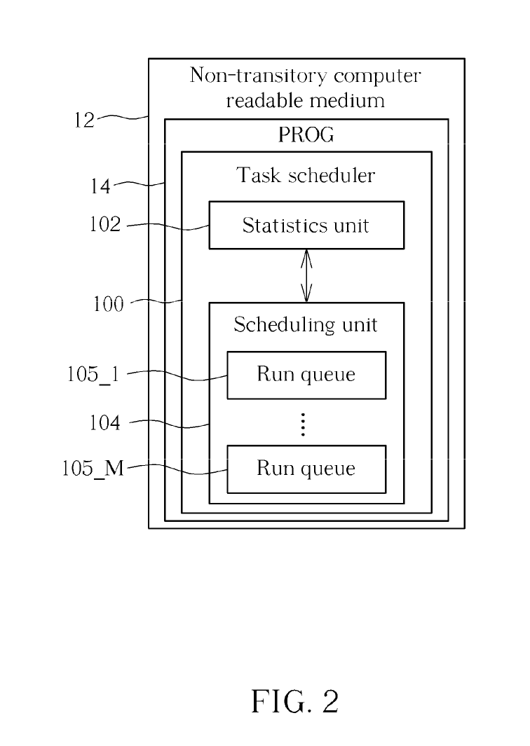

The proposed task scheduling method may be embodied in a software-based manner. FIG. 2 is a diagram illustrating a non-transitory computer readable medium according to an embodiment of the present invention. The non-transitory computer readable medium 12 may be part of the multi-core processor system 10. For example, the non-transitory computer readable medium 12 may be implemented using at least a portion (i.e., part or all) of the main memory 119. For another example, the non-transitory computer readable medium 12 may be implemented using a storage device that is external to the main memory 119 and accessible to each of the processor cores 117 and 118.

In this embodiment, the task scheduler 100 may be coupled to the clusters 112_1-112_N, and arranged to perform the proposed task scheduling method for dispatching a task (e.g., a normal task) in the multi-core processor system 10 based at least partly on distribution of tasks sharing the same specific data and/or accessing the same specific memory address(es). For example, in Linux, the task scheduler 100 employing the proposed task scheduling method may be regarded as an enhanced completely fair scheduler (CFS) used to schedule normal tasks with task priorities lower than that possessed by real-time (RT) tasks. However, this is for illustrative purposes only, and is not meant to be a limitation of the present invention. The task scheduler 100 may be part of an operating system (OS) such as a Linux-based OS or other OS kernel supporting multi-processor task scheduling. Hence, the task scheduler 100 may be a software module running on the multi-core processor system 10. As shown in FIG. 2, the non-transitory computer readable medium 12 may store a program code (PROG) 14. When the program code 14 is loaded and executed by the multi-core processor system 10, the task scheduler 100 may perform the proposed task scheduling method which will be detailed later.

In this embodiment, the task scheduler 100 may include a statistics unit 102 and a scheduling unit 104. The statistics unit 102 may be configured to update thread group information for one or more of the clusters 112_1-112_N. Hence, concerning thread group(s), the statistics unit 102 may update thread group information indicative of the number of tasks of the thread group in one or more of the clusters. For example, a group leader of a thread group is capable of holding the thread group information. The group leader is not necessarily in any run queue of the processor cores 117 and 118. For example, the statistics unit 102 may be configured to manage and record the thread group information for one or more clusters in the group leader of a thread group. However, the thread group information can be recorded at any element that is capable of holding the information, for example, an independent data structure. Each task may have a data structure used to record information of its group leader. Therefore, when a task of a thread group is enqueued into a run queue of a processor core or dequeued from the run queue of the processor core, the thread group information in the group leader of the thread group may be updated by the statistics unit 102 correspondingly. In this way, the number of tasks of the same thread group in different clusters can be known from the recorded thread group information. However, the above is for illustrative purposes only, and is not meant to be a limitation of the present invention. Any means capable of tracking distribution of tasks of the same thread group in the clusters 112_1-112_N may be employed by the statistics unit 102.

The scheduling unit 104 may support different task scheduling schemes, including the proposed thread group aware task scheduling scheme. For example, when a criterion of using the proposed thread group aware tasking scheduling scheme to improve cache locality is met, the scheduling unit 104 may set or adjust run queues of processor cores included in the multi-core processor system 10 according to task distribution information of thread group(s) that is managed by the statistics unit 102; and when the criterion of using the proposed thread group aware tasking scheduling scheme to improve cache locality is not met, the scheduling unit 104 may set or adjust run queues of processor cores included in the multi-core processor system 10 according to a different task scheduling scheme.

Each processor core of the multi-core processor system 10 may be given a run queue managed by the scheduling unit 104. Hence, when the multi-core processor system 10 has M processor cores, the scheduling unit 104 may manage M run queues 105_1-105_M for the M processor cores, respectively, where M is a positive integer and may be adjusted based on actual design consideration. The run queue may be a data structure which records a list of tasks, where the tasks may include a task that is currently running (e.g., a running task) and other task(s) waiting to run (e.g., runnable task(s)). In some embodiments, a processor core may execute tasks included in a corresponding run queue according to task priorities of the tasks. By way of example, but not limitation, the tasks may include programs, application program sub-components, or a combination thereof.

To mitigate or avoid the cache coherence overhead, the scheduling unit 104 may be configured to perform the thread group aware task scheduling scheme. For example, in a situation that a first task belongs to a thread group currently in the multi-core processor system 10, where the thread group has a plurality of tasks sharing same specific data and/or accessing the same specific memory address(es), and the tasks include the first task and at least one second task, the scheduling unit 104 may determine a target processor core in the multi-core processor system 10 based at least partly on distribution of the at least one second task in at least one run queue of at least one processor core in the multi-core processor system 10, and dispatch the first task to the run queue of the target processor core. In accordance with the proposed thread group aware task scheduling scheme, the target processor core may be included in a target cluster of a plurality of clusters of the multi-core processor system 10; and among the clusters, the target cluster may have a largest number of second tasks belonging to the thread group. In a case where the first task is included in one run queue (e.g., the first task may be a running task or a runnable task), the target processor core in the multi-core processor system 10 may be determined based on distribution of the first task and the at least one second task. In another case where the first task is not included in one run queue (e.g., the first task may be a new task or a resumed task), the target processor core in the multi-core processor system 10 may be determined based on distribution of the at least one second task. For better understanding of technical features of the present invention, several task scheduling operations performed by the scheduling unit 104 are discussed as below.

The proposed thread group aware task scheduling scheme may be selectively enabled, depending upon whether the task to be dispatched is a single-threaded process or belongs to a thread group. When the task to be dispatched is a single-threaded process, the scheduling unit 104 may use another task scheduling scheme to control the task dispatch (e.g., adding the task to one run queue or making the task migrate from one run queue to another run queue). When the task to be dispatched is part of a thread group currently in the multi-core processor system 10, the scheduling unit 104 may use the proposed thread group aware task scheduling scheme to control the task dispatch (e.g., adding the task to one run queue or making the task migrate from one run queue to another run queue) under the premise that the load balance requirement is met. Otherwise, the scheduling unit 104 may use another task scheduling scheme to control the task dispatch of the task belonging to the thread group.

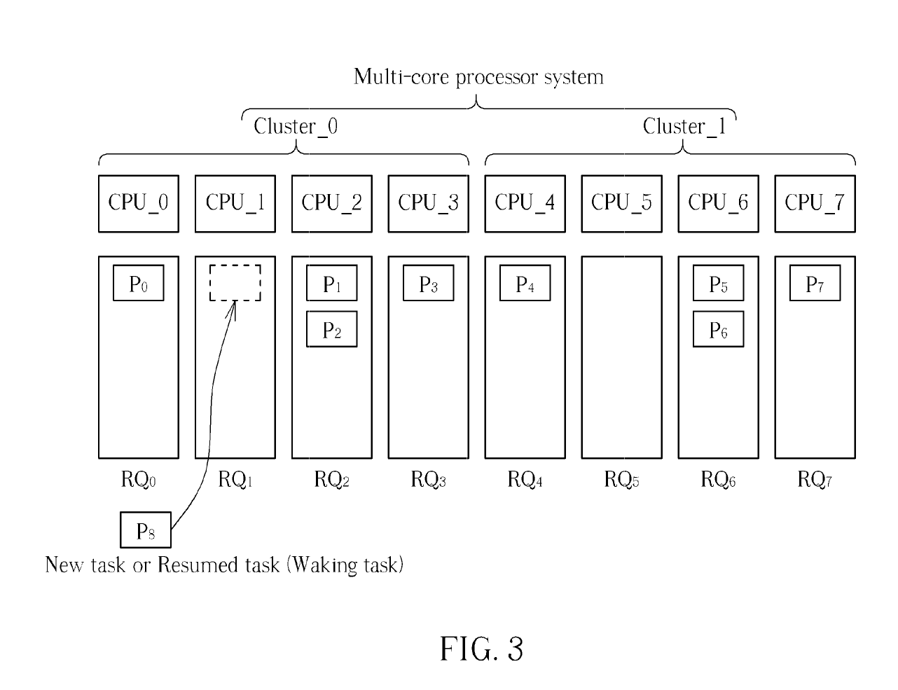

With regard to each of the following examples shown in FIG. 3-FIG. 7, the scheduling unit 104 of the task scheduler 100 may be executed to find an idlest processor core among selected processor cores in the multi-core processor system 10. For example, the selected processor cores checked by the scheduling unit 104 for load balance may be all processor cores included in the multi-core processor system 10. In one exemplary implementation, the program code of the scheduling unit 104 may be executed by a processor core that invokes a new or resumed task. In another exemplary implementation, the program code of the scheduling unit 104 may be executed in a centralized manner, regardless of which processor core that invokes a new or resumed task.

For clarity and simplicity, the following examples shown in FIG. 3-FIG. 7 assume that the multi-core processor system 10 has only two clusters 112_1 and 112_N (N=2) denoted by Cluster_0 and Cluster_1, respectively; one cluster 112_1 denoted by Cluster_0 has only four processor cores 117 denoted by CPU_0, CPU_1, CPU_2, and CPU_3, respectively; and the other cluster 112_N denoted by Cluster_1 has only four processor cores 118 denoted by CPU_4, CPU_5, CPU_6, and CPU_7, respectively. Hence, the scheduling unit 104 may assign run queues 105_1-105_M (M=8) denoted by RQ₀-RQ₇ to the processor cores CPU_0-CPU_7, respectively. In addition, in these examples, all processor cores CPU_0-CPU_7 of the multi-core processor system 10, including a processor core that invokes a new or resumed task, may be treated by the scheduling unit 104 as selected processor cores that will be checked to determine how to assign the new or resumed task to one of the selected processor cores.

FIG. 3 is a diagram illustrating a first task scheduling operation which dispatches one task that is a single-threaded process to a run queue of a processor core (e.g., an idle processor core). In this example, before a task P₈ is required to be added to one of the run queues RQ₀-RQ₇ for execution, the run queue RQ₀ may include one task P₀; the run queue RQ₂ may include two tasks P₁ and P₂; the run queue RQ₃ may include one task P₃; the run queue RQ₄ may include one task P₄; the run queue RQ₆ may include two tasks P₅ and P₆; and the run queue RQ₇ may include one task P₇. Each of the tasks P₀-P₇ in some of the run queues RQ₀-RQ₇ and the task P₈ to be dispatched to one of the run queues RQ₀-RQ₇ may be a single-threaded process. In this example, the multi-core processor system 10 currently has no thread group having multiple tasks sharing same specific data and/or accessing same specific memory address(es).

It is possible that the system may create a new task, or a task may be added to a wait queue to wait for requested system resource(s) and then resumed when the requested system resource(s) is available. In this example, the task P₈ may be a new task or a resumed task (e.g., a waking task currently being woken up) that is not included in run queues RQ₀-RQ₇ of the multi-core processor system 10. Since the task P₈ is a single-threaded process, the proposed thread group aware task scheduling scheme may not be enabled. By way of example, another task scheduling scheme may be enabled by the scheduling unit 104. Hence, the scheduling unit 104 may find an idlest processor core (e.g., an idle processor core with no running task and/or runnable task, or a lightest-loaded processor with non-zero processor core load (if there is no idle processor core)) among the processor cores CPU_0-CPU_7, and add the task P₈ to a run queue of the idlest processor core. In this embodiment, an idle processor core is defined as a processor core with an empty run queue (e.g. no running and runnable task). It should be noted that the processor core load of an idle processor core may have a zero value or a non-zero value. This is because the processor core load of each processor core may be calculated based on historical information of the processor core. For example, concerning evaluation of the processor core load of a processor core, current task(s) in a run queue of the processor core and past task(s) in the run queue of the processor core may be taken into consideration. In addition, during evaluation of the processor core load of the processor core, a weighting factor may be given to a task based on a task priority, a ratio of a task runnable time to a total task lifetime, etc.

In a case where the processor cores CPU_0-CPU_7 have at least one idle processor core with no running task and/or runnable task, the scheduling unit 104 may select one of the at least one idle processor core as the idlest processor core. In another case where the processor cores CPU_0-CPU_7 have no idle processor core but have at least one lightest-loaded processor core with non-zero processor core load, the scheduling unit 104 may select one of the at least one lightest-loaded processor core as the idlest processor core. As shown in FIG. 3, the processor cores CPU_1 and CPU_5 are both idle. The scheduling unit 104 may dispatch the task P₈ to one of the run queues RQ₁ and RQ₅. In this example, the scheduling unit 104 may add the task P₈ to the run queue RQ₁ possessed by the idle processor core CPU_1, as shown in FIG. 3.

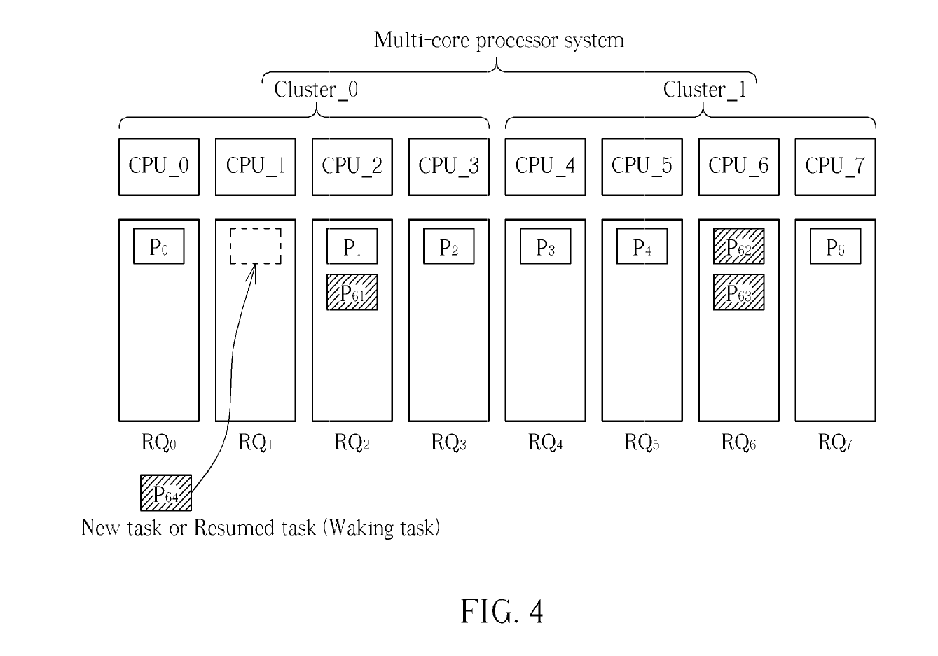

FIG. 4 is a diagram illustrating a second task scheduling operation which dispatches one task that belongs to a thread group to a run queue of a processor core (e.g., an idle processor core). In this example, before a task P₆₄ is required to be added to one of the run queues RQ₀-RQ₇ for execution, the run queue RQ₀ may include one task P₀; the run queue RQ₂ may include two tasks P₁ and P₆₁; the run queue RQ₃ may include one task P₂; the run queue RQ₄ may include one task P₃; the run queue RQ₅ may include one task P₄; the run queue RQ₆ may include two tasks P₆₂ and P₆₃; and the run queue RQ₇ may include one task P₅. Each of the tasks P₀-P₅ in some of the run queues RQ₀-RQ₇ may be a single-threaded process, and the tasks P₆₁-P₆₃ in some of the run queues RQ₀-RQ₇ and the task P₆₄ to be dispatched to one of the run queues RQ₀-RQ₇ may belong to the same thread group. In this example, the multi-core processor system 10 currently has one thread group having multiple tasks P₆₁-P₆₄ sharing same specific data and/or accessing same specific memory address(es).

In this example, the task P₆₄ may be a new task or a resumed task (e.g., a waking task currently being woken up) that is not included in run queues RQ₀-RQ₇ of the multi-core processor system 10. It should be noted that, with regard to the multi-core processor system performance, load balance may be more critical than cache coherence overhead reduction. Hence, the policy of achieving load balance may override the policy of improving cache locality. As shown in FIG. 4, two tasks P₆₂ and P₆₃ of the same thread group to which the task₆₄ belongs are included in run queue RQ₆ of the processor core CPU_6 of the cluster Cluster_1, and one task P₆₁ of the same thread group to which the task P₆₄ belongs is included in run queue RQ₂ of the processor core CPU_2 of the cluster Cluster_0. Hence, among the clusters Cluster_0 and Cluster_1, the cluster Cluster_1 has a largest number of tasks belonging to the same thread group to which the task P₆₄ belongs. If the proposed thread group aware scheme is performed, the scheduling unit 104 may dispatch the task P₆₄ to one run queue of the cluster Cluster_1 for achieving improved cache locality. However, as can be known from FIG. 4, the processor core CPU_1 of the cluster Cluster_0 may be the only one idle processor core with no running task and/or runnable task in the multi-core processor system 10. Dispatching the task P₆₄ to one run queue of the cluster Cluster_1 fails to achieve load balance. In this embodiment, another task scheduling operation may be enabled by the scheduling unit 104. Hence, the scheduling unit 104 may find an idlest processor core (i.e., an idle processor core with no running task and/or runnable task, or a lightest-loaded processor core (if there is no idle processor core)) among the processor cores CPU_0-CPU_7, and add the task P₆₄ to a run queue of the idlest processor core. Since there is only one idle processor core in the multi-core processor system 10, the only option available to the scheduling unit 104 may be adding the task P₆₄ to the run queue RQ₁ possessed by the idle processor core CPU_1, as shown in FIG. 4.

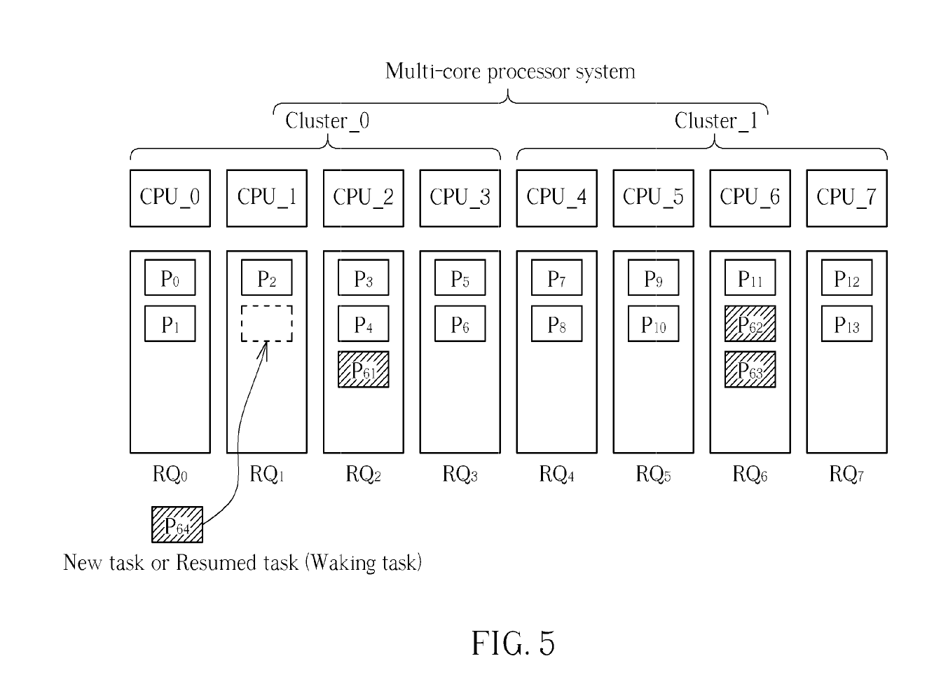

FIG. 5 is a diagram illustrating a third task scheduling operation which dispatches one task that belongs to a thread group to a run queue of a processor core (e.g., a lightest-loaded processor core). In this example, before a task P₆₄ is required to be added to one of the run queues RQ₀-RQ₇ for execution, the run queue RQ₀ may include two tasks P₀ and P₁; the run queue RQ₁ may include one task P₂; the run queue RQ₂ may include three tasks P₃, P₄ and P₆₁; the run queue RQ₃ may include two tasks P₅ and P₆; the run queue RQ₄ may include two tasks P₇ and P₈; the run queue RQ₅ may include two tasks P₉ and P₁₀; the run queue RQ₆ may include three tasks P₁₁, P₆₂ and P₆₃; and the run queue RQ₇ may include two tasks P₁₂ and P₁₃. Each of the tasks P₀-P₁₃ in some of the run queues RQ₀-RQ₇ may be a single-threaded process, and the tasks P₆₁-P₆₃ in some of the run queues RQ₀-RQ₇ and the task P₆₄ to be dispatched to one of the run queues RQ₀-RQ₇ may belong to the same thread group. In this example, the multi-core processor system 10 currently has one thread group having multiple tasks P₆₁-P₆₄ sharing same specific data and/or accessing same specific memory address(es).

In this example, the task P₆₄ may be a new task or a resumed task (e.g., a waking task currently being woken up) that is not included in run queues RQ₀-RQ₇ of the multi-core processor system 10. As mentioned above, concerning the multi-core processor system performance, load balance may be more critical than cache coherence overhead reduction. Hence, the policy of achieving load balance may override the policy of improving cache locality. As shown in FIG. 5, among the clusters Cluster_0 and Cluster_1, the cluster Cluster_1 has a largest number of tasks belonging to the thread group to which the task P₆₄ belongs. If the proposed thread group aware task scheduling scheme is performed, the scheduling unit 104 may dispatch the task P₆₄ to one run queue of the cluster Cluster_1 for achieving improved cache locality. However, as can be known from FIG. 5, none of the clusters Cluster_0 and Cluster_1 has one or more idle processor cores, and the processor core CPU_1 of the cluster Cluster_0 may be the only one lightest-loaded processor core with non-zero processor core load in the multi-core processor system 10. Dispatching the task P₆₄ to one run queue of the cluster Cluster_1 fails to achieve load balance. In this embodiment, another task scheduling operation may be enabled by the scheduling unit 104. The only option available to the scheduling unit 104 may be adding the task P₆₄ to the run queue RQ₁ possessed by the lightest-loaded processor core CPU_1.

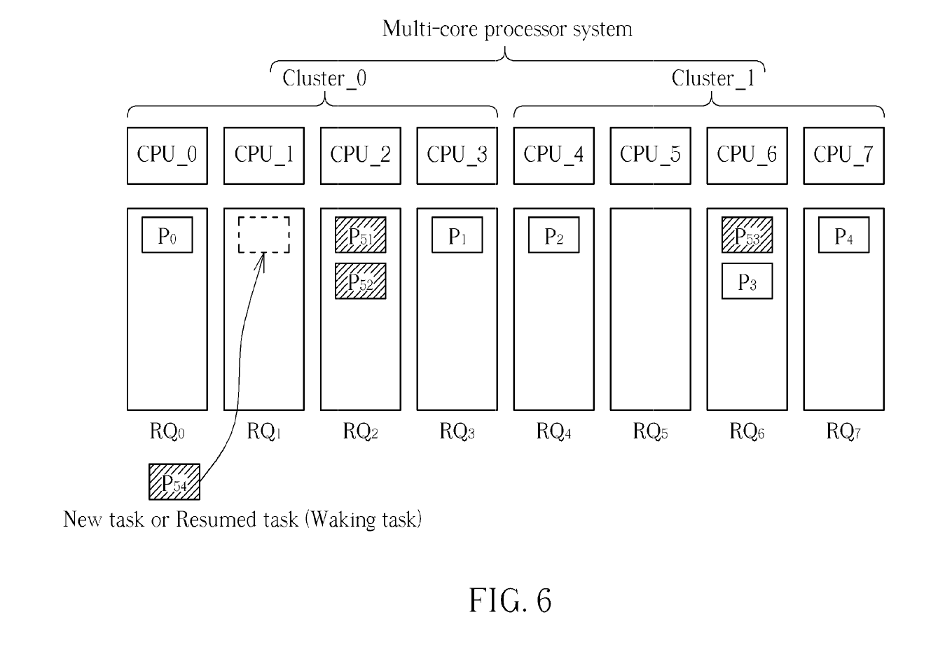

FIG. 6 is a diagram illustrating a fourth task scheduling operation which dispatches one task that belongs to a thread group to a run queue of a processor core (e.g., an idle processor core). In this example, before a task P₅₄ is required to be added to one of the run queues RQ₀-RQ₇ for execution, the run queue RQ₀ may include one task P₀; the run queue RQ₂ may include two tasks P₅₁ and P₅₂; the run queue RQ₃ may include one task P₁; the run queue RQ₄ may include one task P₂; the run queue RQ₆ may include two tasks P₅₃ and P₃; and the run queue RQ₇ may include one task P₄. Each of the tasks P₀-P₄ in some of the run queues RQ₀-RQ₇ may be a single-threaded process, and the tasks P₅₁-P₅₃ in some of the run queues RQ₀-RQ₇ and the task P₅₄ to be dispatched to one of the run queues RQ₀-RQ₇ may belong to the same thread group. In this example, the multi-core processor system 10 currently has one thread group having multiple tasks P₅₁-P₅₄ sharing same specific data and/or accessing same specific memory address(es).

In this example, the task P₅₄ may be a new task or a resumed task (e.g., a waking task currently being woken up) that is not included in run queues RQ₀-RQ₇ of the multi-core processor system 10. The scheduling unit 104 may first detect that each of the clusters Cluster_0 and Cluster_1 has at least one idle processor core with no running task and/or runnable task. Hence, the scheduling unit 104 may have the chance to perform the thread group aware task scheduling scheme for improving cache locality while achieving desired load balance. For example, since each of the clusters Cluster_0 and Cluster_1 has at least one idle processor core with no running task and/or runnable task, dispatching the task P₅₄ to a run queue of an idle processor core in any of the clusters Cluster_0 and Cluster_1 may achieve the desired load balance. In addition, since the task P₅₄ is not added to a run queue yet, distribution of tasks P₅₁-P₅₃ in run queues of the multi-core processor system 10 may be considered by the scheduling unit 104 to determine a target cluster to which the task P₅₄ should be dispatched for achieving improved cache locality. As shown in FIG. 6, two tasks P₅₁ and P₅₂ of the same thread group to which the task P₅₄ belongs are included in run queue RQ₂ of the processor core CPU_2 of the cluster Cluster_0, and one task P₅₃ of the same thread group to which the task P₅₄ belongs is included in run queue RQ₆ of the processor core CPU_6 of the cluster Cluster_1. Hence, among the clusters Cluster_0 and Cluster_1, the cluster Cluster_0 has a largest number of tasks belonging to the thread group to which the task P₅₄ belongs. When the proposed thread group aware task scheduling scheme is performed under the condition that each of the clusters Cluster_0 and Cluster_1 has at least one idle processor core with no running task and/or runnable task, the scheduling unit 104 may refer to the task distribution of the thread group to dispatch the task P₅₄ to run queue RQ₁ in the cluster Cluster_0, as shown in FIG. 6. In this way, cache locality can be improved under the premise that the load balance requirement is met.

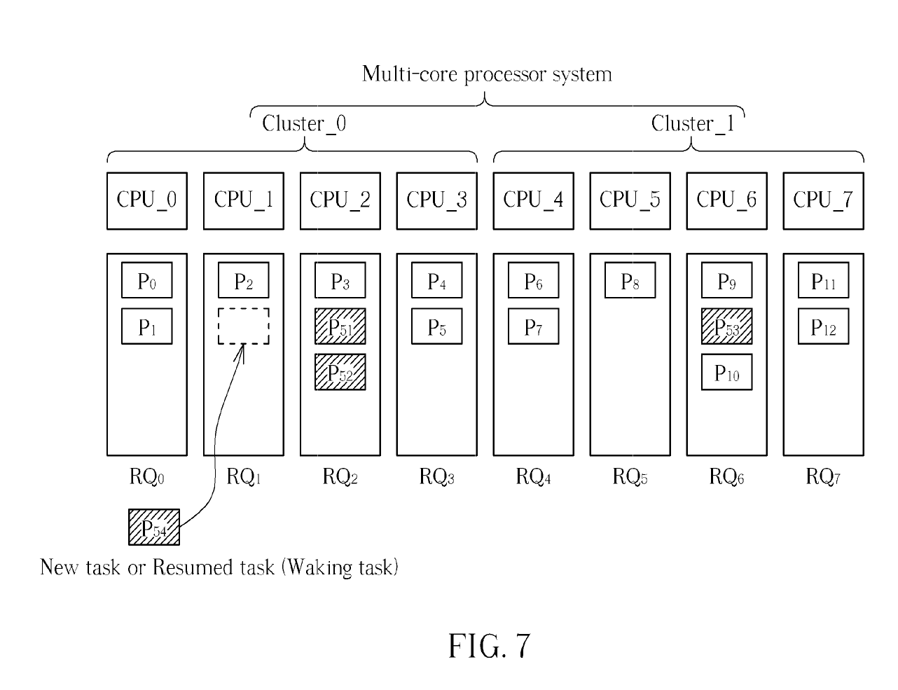

FIG. 7 is a diagram illustrating a fifth task scheduling operation which dispatches one task that belongs to a thread group to a run queue of a processor core (e.g., a lightest-loaded processor core). In this example, before a task P₅₄ is required to be added to one of the run queues RQ₀-RQ₇ for execution, the run queue RQ₀ may include two tasks P₀ and P₁; the run queue RQ₁ may include one task P₂; the run queue RQ₂ may include three tasks P₃, P₅₁ and P₅₂; the run queue RQ₃ may include two tasks P₄ and P₅; the run queue RQ₄ may include two tasks P₆ and P₇; the run queue RQ₅ may include one task P₈; the run queue RQ₆ may include three tasks P₉, P₅₃ and P₁₀; and the run queue RQ₇ may include two tasks P₁₁ and P₁₂. Each of the tasks P₀-P₁₂ in some of the run queues RQ₀-RQ₇ may be a single-threaded process, and the tasks P₅₁-P₅₃ in some of the run queues RQ₀-RQ₇ and the task P₅₄ to be dispatched to one of the run queues RQ₀-RQ₇ may belong to the same thread group. In this example, the multi-core processor system 10 currently has one thread group having multiple tasks P₅₁-P₅₄ sharing same specific data and/or accessing same specific memory address(es).

In this example, the task P₅₄ may be a new task or a resumed task (e.g., a waking task currently being woken up) that is not included in run queues RQ₀-RQ₇ of the multi-core processor system 10. The scheduling unit 104 may first detect that each of the clusters Cluster_0 and Cluster_1 has no idle processor core but has at least one lightest-loaded processor core with non-zero processor core load. Further, the scheduling unit 104 may evaluate processor core load statuses of lightest-loaded processor cores in the clusters Cluster_0 and Cluster_1. Suppose that the scheduling unit 104 finds that lightest-loaded processor core(s) of the cluster Cluster_0 and lightest-loaded processor core(s) of the cluster Cluster_1 have the same processor core load (i.e., the same processor core load evaluation value). Hence, the scheduling unit 104 may have the chance to perform the thread group aware task scheduling scheme for improving cache locality while achieving desired load balance. For example, since each of the clusters Cluster_0 and Cluster_1 has at least one lightest-loaded processor core with the same non-zero processor core load, dispatching the task P₅₄ to a run queue of a lightest-loaded processor core in any of the clusters Cluster_0 and Cluster_1 may achieve the desired load balance. As shown in FIG. 7, the processor core CPU_1 may be the only one lightest-loaded processor core in the cluster Cluster_0, and the processor core CPU_5 may be the only one lightest-loaded processor core in the cluster Cluster_1, where the processor cores CPU_1 and CPU_5 may have the same processor core load. Hence, based on the load balance policy, one of the processor cores CPU_1 and CPU_5 may be selected as a target processor core used for executing the task P₅₄.

In addition, since the task P₅₄ is not added to one run queue yet, distribution of tasks P₅₁-P₅₃ in run queues of the multi-core processor system 10 may be considered by the scheduling unit 104 to determine a target cluster to which the task P₅₄ should be dispatched for achieving the improved cache locality. As shown in FIG. 7, two tasks P₅₁ and P₅₂ of the same thread group to which the task P₅₄ belongs are included in run queue RQ₂ of the processor core CPU_2 of the cluster Cluster_0, and one task P₅₃ of the same thread group to which the task P₅₄ belongs is included in run queue RQ₆ of the processor core CPU_6 of the cluster Cluster_1. Hence, among the clusters Cluster_0 and Cluster_1, the cluster Cluster_0 has a largest number of tasks belonging to the thread group to which the task P₅₄ belongs. When the proposed thread group aware task scheduling scheme is performed under the condition that each of the clusters Cluster_0 and Cluster_1 has at least one lightest-loaded processor core with the same non-zero processor core load, the scheduling unit 104 may dispatch the task P₅₄ to run queue RQ₁ in the cluster Cluster_0, as shown in FIG. 7. In this way, cache locality can be improved under the premise that the load balance requirement is met.

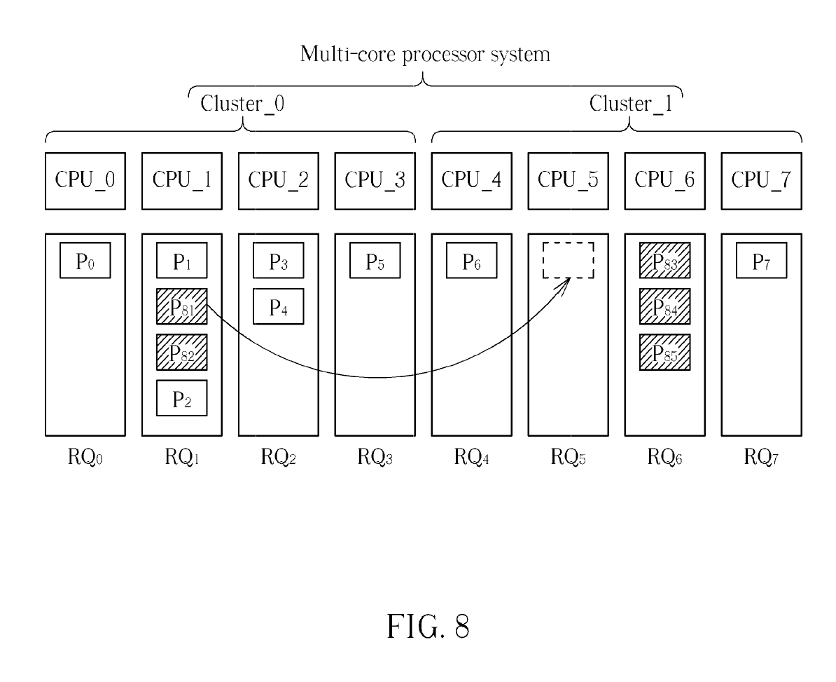

With regard to each of the following examples shown in FIG. 8-FIG. 11, the scheduling unit 104 of the task scheduler 100 may be executed to find a busier processor core (e.g., a busiest processor core) among selected processor cores in the multi-core processor system 10. For example, the selected processor cores checked by the scheduling unit 104 for task migration/load balance may be some processor cores included in the multi-core processor system 10, where the selected processor cores may belong to the same cluster or different clusters. For another example, the selected processor cores checked by the scheduling unit 104 for task migration/load balance may be all processor cores included in the multi-core processor system 10. In one exemplary implementation, the program code of the scheduling unit 104 may be executed by a processor core that triggers a load balance procedure. By way of example, but not limitation, each of the processor cores in the multi-core processor system 10 may be configured to trigger one load balance procedure every certain period of time, where the time period length may be a fixed value or a time-varying value, and/or selection of processor cores to be checked in each load balance procedure may be fixed or adaptively adjusted. A processor core that triggers a current load balance procedure is one of the selected processor cores checked by the scheduling unit 104. For example, a processor core load of the processor core that triggers the current load balance procedure may be compared with processor core loads of other processor cores in the selected processor cores. When a specific processor core of the selected processor cores has a processor core load heavier than that possessed by the processor core that triggers the load balance procedure, a task may be pulled from the specific processor core (e.g., a more busier processor core) to the processor core that triggers the load balance procedure (e.g., a less busier processor core or an idle processor core). In one exemplary embodiment, the specific processor core may be the busiest processor core among the selected processor cores checked by the scheduling unit 104. It should be noted that, in an alternative design, the program code of the scheduling unit 104 may be executed in a centralized manner, regardless of which processor core that triggers a load balance procedure.

For clarity and simplicity, the following examples shown in FIG. 8-FIG. 11 assume that the selected processor cores checked by the scheduling unit 104 for task migration/load balance have eight processor cores denoted by CPU_0-CPU_7, respectively. In a case where the multi-core processor system 10 has only two clusters 112_1 and 112_N (N=2) denoted by Cluster_0 and Cluster_1, respectively; one cluster 112_1 denoted by Cluster_0 has only four processor cores 117 denoted by CPU_0, CPU_1, CPU_2, and CPU_3, respectively; and the other cluster 112_N denoted by Cluster_1 has only four processor cores 118 denoted by CPU_4, CPU_5, CPU_6, and CPU_7, respectively. In this case, all of the processor cores included in the multi-core processor system 10 may be treated as selected processor cores. In addition, the scheduling unit 104 may assign run queues 105_1-105_M (M=8) denoted by RQ₀-RQ₇ to the selected processor cores CPU_0-CPU_7, respectively. In another case where the multi-core processor system 10 has more than two clusters and/or at least one of the clusters 117 and 118 has more than four processor cores, the scheduling unit 104 merely treats some processor cores included in the multi-core processor system 10 as the selected processor cores CPU_0-CPU_7 shown in FIG. 8-FIG. 11. To put it simply, the selected processor cores CPU_0-CPU_7 checked for task migration/load balance may be at least a portion (i.e., part or all) of processor cores included in the multi-core processor system 10, depending upon a selection setting corresponding to the processor core that triggers the load balance procedure. Hence, concerning any of the examples shown in FIG. 8-FIG. 11, the selected processor cores CPU_0-CPU_3 may be part or all of the processor cores belonging to the same cluster Cluster_0, the selected processor cores CPU_4-CPU_7 may be part or all of the processor cores belonging to the same cluster Cluster_1, and/or the clusters Cluster_0 and Cluster_1 may be part or all of the clusters used in the same multi-core processor system.

In the examples of FIG. 3-FIG. 7, a load balance procedure may be executed when there is a new task or a resumed task (e.g., a waking task currently being woken up) that is not included in any run queue of the multi-core processor system 10 and thus required to be added to one run queue of the multi-core processor system 10 for execution. In practice, load balance procedures may be executed due to other trigger events. For example, when the task scheduler 100 finds that there are no task(s) in run queue(s) of the multi-core processor system 10, a load balance procedure may be executed to pull a task from a run queue of a busier processor core among the selected processor cores, such as a busiest processor core (i.e., a heaviest-loaded processor core) among the selected processor cores, to a run queue of an idle processor core with no running task and/or runnable task (which may be a processor core that triggers the load balance procedure due to its empty run queue). For another example, when the task scheduler 100 finds that a predetermined time interval is elapsed (e.g., a timer is expired), a load balance procedure may be executed to pull a task from a run queue of a more busier processor core among the selected processor cores, such as a busiest processor core (e.g., a heaviest-loaded processor core) among the selected processor cores, to a run queue of a less busier processor core (which may be a processor core that triggers the load balance procedure due to its timer expiration). It is possible that the processor core that triggers the load balance procedure due to its timer expiration may be an idlest processor core (e.g., an idle processor core with no running task and/or runnable task, or a lightest-loaded processor core with non-zero processor core load (if there is no idle processor core)) among the selected processor cores. Assuming that the busiest processor core (e.g., the heaviest-loaded processor core) among the selected processor cores may be selected as a target source of the task migration, a task in a run queue of the busiest processor core (e.g., heaviest-loaded processor core) in the selected processor cores of the multi-core processor system 10 may undergo migration from one cluster to another cluster. Similarly, under the premise that the load balance requirement is met, the proposed thread group aware task scheduling scheme may be involved in controlling the task migration to reduce or avoid the cache coherence overhead. In other words, when a target source and a target destination of a task migration associated with a current load balance procedure are two selected processor cores in different clusters, the proposed thread group aware task scheduling scheme may be enabled to control the task migration if the load balance requirement can be met.

FIG. 8 is a diagram illustrating a sixth task scheduling operation which makes one task that belongs to a thread group migrate from a run queue of a processor core (e.g., a heaviest-loaded processor core) in one cluster to a run queue of a processor core (e.g., an idle processor core) in another cluster. Assume that the processor core CPU_5 triggers a load balance procedure due to empty run queue or timer expiration. In this example, at the time the load balance procedure begins, the run queue RQ₀ may include one task P₀; the run queue RQ₁ may include four tasks P₁, P₈₁, P₈₂, and P₂; the run queue RQ₂ may include two tasks P₃ and P₄; the run queue RQ₃ may include one task P₅; the run queue RQ₄ may include one task P₆; the run queue RQ₆ may include three tasks P₈₃, P₈₄, and P₈₅; and the run queue RQ₇ may include one task P₇. Each of the tasks P₀-P₇ in some of the run queues RQ₀-RQ₇ may be a single-threaded process, and the tasks P₈₁-P₈₅ in some of the run queues RQ₀-RQ₇ may belong to the same thread group. In this example, the multi-core processor system 10 currently has one thread group having multiple tasks P₈₁-P₈₅ sharing same specific data and/or accessing same specific memory address(es).

When the load balance procedure begins, the scheduling unit 104 may compare processor core loads of the selected processor cores CPU_0-CPU_7 to find a target source of the task migration. In this example shown in FIG. 8, the processor core CPU_5 is also an idle processor core with no running task and/or runnable task. However, this is for illustrative purposes only, and is not meant to be a limitation of the present invention. That is, a processor core that triggers a load balance procedure due to timer expiration may not necessarily be an idlest processor core (e.g., an idle processor core with no running task and/or runnable task, or a lightest-loaded processor core with non-zero processor core load (if there is no idle processor core)) among the selected processor cores checked by the scheduling unit 104 for task migration/load balance. In this example, compared to the processor core CPU_5 (which may be the processor core that triggers the load balance procedure in this example), each of the processor cores CPU_0-CPU_4 and CPU_6-CPU_7 shown in FIG. 8 may have a heavier processor core and therefore may be regarded as one candidate source of the task migration.

By way of example, but not limitation, the scheduling unit 104 may be configured to find a busiest processor core (e.g., a heaviest-loaded processor core with non-zero processor core load) as the target source of the task migration. In this example, the busiest processor core among the selected processor cores CPU_0-CPU_7 may be the processor core CPU_1 in cluster Cluster_0. Further, the run queue RQ₁ of the busiest processor core CPU_1 includes tasks P₈₁ and P₈₂ belonging to the same thread group currently in the multi-core processor system 10.

During the load balance procedure, the proposed thread group aware task scheduling scheme may be enabled for achieving improved cache locality when task migration from one cluster to another cluster is needed (e.g., the busiest processor core (which may act as the target source of the task migration) and the processor core that triggers the load balance procedure (which may act as the target destination of the task migration) of the selected processor cores are included in different clusters) and a run queue of the target source of the task migration (e.g., the busiest processor core among the selected processor cores) includes at least one task belonging to a thread group having multiple tasks sharing same specific data and/or accessing same specific memory address(es). Hence, the scheduling unit 104 may perform the proposed thread group aware task scheduling scheme to determine whether to make one task (e.g., P₈₁ or P₈₂) of the thread group migrate from the run queue RQ₁ of the processor core CPU_1 (which is the busiest processor core among the selected processor cores) to the run queue RQ₅ of the processor core CPU_5 (which is the processor core that triggers the load balance procedure, and is, for example, the idlest processor core) for cache coherence overhead reduction.

Consider a case where the task P₈₁ is selected as a candidate task to migrate from a current cluster Cluster_0 to a different cluster Cluster_1. The scheduling unit 104 may refer to distribution of tasks belong to the same thread group to judge whether task migration of the candidate task should be actually executed. As shown in FIG. 8, the thread group includes a first task (e.g., task P₈₁) selected as a candidate task for task migration, and further includes a plurality of second tasks (e.g., tasks P₈₂-P₈₅), each not selected as a candidate task for task migration. The distribution of the first task and the second tasks belonging to the same thread group is checked. Concerning the first and second tasks (e.g., tasks P₈₁-P₈₅), two tasks P₈₁ and P₈₂ are included in run queue RQ₁ of the processor core CPU_1 of the cluster Cluster_0, and three tasks P₈₃, P₈₄, and P₈₅ are included in run queue RQ₆ of the processor core CPU_6 of the cluster Cluster_1. Hence, among the clusters Cluster_0 and Cluster_1, the cluster Cluster_1 has a largest number of tasks belonging to the thread group. The first task is included in one run queue of the cluster Cluster_0. Based on the checking result of the distribution of first task and second tasks, the scheduling unit 104 may judge that the candidate task should migrate from a current cluster to a different cluster. The scheduling unit 104 may make the task P₈₁ migrate from the run queue RQ₁ of the processor core CPU_1 (which is the heaviest-loaded processor core among the selected processor cores) to the run queue RQ₅ of the processor core CPU_5 (which is the processor core that triggers the load balance procedure), as shown in FIG. 8.

It should be noted that the run queue RQ₁ of the processor core CPU_1 may include more than one task belonging to a thread group currently in the multi-core processor system 10. Hence, any task that belongs to the thread group and is included in the run queue RQ₁ of the processor core CPU_1 may be selected as a candidate task to migrate from the current cluster Cluster_0 to a different cluster Cluster_1. Consider another case where the task P₈₂ is selected as a candidate task. As shown in FIG. 8, the thread group includes a first task (e.g., task P₈₂) selected as a candidate task for task migration, and further includes a plurality of second tasks (i.e., tasks P₈₁ and P₈₃-P₈₅), each not selected as a candidate task for task migration. The distribution of the first task and the second tasks belonging to the same thread group is checked. Concerning the first and second tasks (i.e., tasks P₈₁-P₈₅), two tasks P₈₁ and P₈₂ are included in run queue RQ₁ of the processor core CPU_1 of the cluster Cluster_0, and three tasks P₈₃, P₈₄, and P₈₅ are included in run queue RQ₆ of the processor core CPU_6 of the cluster Cluster_1. Hence, among the clusters Cluster_0 and Cluster_1, the cluster Cluster_1 has a largest number of tasks belonging to the thread group. The first task is included in one run queue of the cluster Cluster_0. Based on the checking result of the distribution of first task and second tasks, the scheduling unit 104 may judge that the candidate task should migrate from a current cluster to a different cluster. The scheduling unit 104 may make the task P₈₂ migrate from the run queue RQ₁ of the processor core CPU_1 (which is the heaviest-loaded processor core among the selected processor cores) to the run queue RQ₅ of the processor core CPU_5 (which is the processor core that triggers the load balance procedure).

As mentioned above, the proposed thread group aware task scheduling scheme performed by the scheduling unit 104 may select a candidate task (e.g., a task that belongs to a thread group and is included in a run queue of a busiest processor core among the selected processor cores), and check the task distribution of the thread group in the clusters to determine whether the candidate task should undergo task migration to migrate from a current cluster to a different cluster. Hence, it is possible that the task distribution of the thread group may discourage task migration of the candidate task.

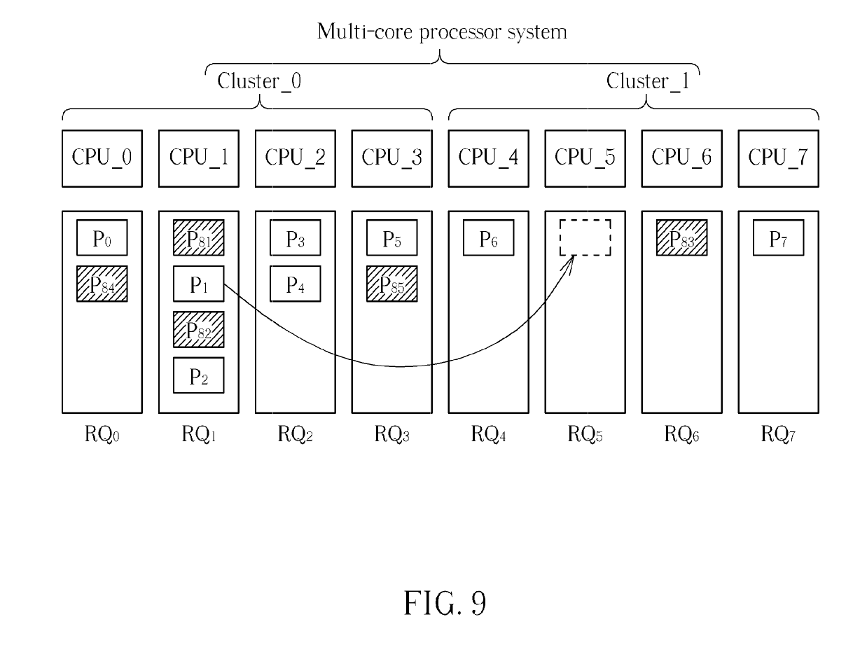

FIG. 9 is a diagram illustrating a seventh task scheduling operation which makes one task that is a single-threaded process migrate from a run queue of a processor core (e.g., a heaviest-loaded processor core) in one cluster to a run queue of a processor core (e.g., an idle processor core) in another cluster, wherein the thread-group migration discipline is obeyed. Assume that the processor core CPU_5 triggers a load balance procedure due to empty run queue or timer expiration. In this example, at the time the load balance procedure begins, the run queue RQ₀ may include two tasks P₀ and P₈₄; the run queue RQ₁ may include four tasks P₁, P₈₁, P₈₂, and P₂; the run queue RQ₂ may include two tasks P₃ and P₄; the run queue RQ₃ may include two tasks P₅ and P₈₅; the run queue RQ₄ may include one task P₆; the run queue RQ₆ may include one task P₈₃; and the run queue RQ₇ may include one task P₇. Each of the tasks P₀-P₇ in some of the run queues RQ₀-RQ₇ may be a single-threaded process, and the tasks P₈₁-P₈₅ in some of the run queues RQ₀-RQ₇ may belong to the same thread group. In this example, the multi-core processor system 10 currently has one thread group having multiple tasks P₈₁-P₈₅ sharing same specific data and/or accessing same specific memory address(es).

Similarly, when the load balance procedure begins, the scheduling unit 104 may compare processor core loads of the selected processor cores CPU_0-CPU_7 to find a target source of the task migration. In this example shown in FIG. 9, the processor core CPU_5 is an idle processor core with no running task and/or runnable task. However, this is for illustrative purposes only, and is not meant to be a limitation of the present invention. That is, a processor core that triggers a load balance procedure due to timer expiration may not necessarily be an idlest processor core (e.g., an idle processor core with no running task and/or runnable task, or a lightest-loaded processor core with non-zero processor core load (if there is no idle processor core)) among all selected processor cores. In this example, compared to the processor core CPU_5 (which is the processor core that triggers the load balance procedure), each of the processor cores CPU_0-CPU_4 and CPU_6-CPU_7 shown in FIG. 9 may have a heavier processor core and therefore may be regarded as one candidate source of the task migration.

By way of example, but not limitation, the scheduling unit 104 may be configured to find a busiest processor core (e.g., a heaviest-loaded processor core with non-zero processor core load) as the target source of the task migration. In this example, the busiest processor core among the selected processor cores CPU_0-CPU_7 may be the processor core CPU_1 in cluster Cluster_0. Further, the run queue RQ₁ of the busiest processor core CPU_1 may include tasks P₈₁ and P₈₂ belonging to the same thread group currently in the multi-core processor system 10.

Consider a case where the task P₈₁ is selected as a candidate task to migrate from a current cluster Cluster_0 to a different cluster Cluster_1. As shown in FIG. 9, the thread group includes a first task (e.g., task P₈₁) selected as a candidate task for task migration, and further includes a plurality of second tasks (i.e., tasks P₈₂-P₈₅), each not selected as a candidate task for task migration. The distribution of the first task and the second tasks belonging to the same thread group is checked. Concerning the first and second tasks (i.e., tasks P₈₁-P₈₅), one task P₈₄ is included in run queue RQ₀ of the processor core CPU_0 of the cluster Cluster_0, two tasks P₈₁ and P₈₂ are included in run queue RQ₁ of the processor core CPU_1 of the cluster Cluster_0, one task P₈₅ is included in run queue RQ₃ of the processor core CPU_3 of the cluster Cluster_0 and one task P₈₃ is included in run queue RQ₆ of the processor core CPU_6 of the cluster Cluster_1. Hence, among the clusters Cluster_0 and Cluster_1, the cluster Cluster_0 has a largest number of tasks belonging to the thread group. The first task is included in one run queue of the cluster Cluster_0. The processor core that triggers the load balance procedure (e.g., the processor core CPU_5) is included in the cluster Cluster_1 that has a smaller number of tasks belonging to the same thread group. Based on the checking result of the distribution of first task and second tasks, the scheduling unit 104 may judge that the candidate task should stay in the current cluster Cluster_0. By way of example, another task scheduling scheme may be performed by the scheduling unit 104 to move a single-threaded process that is earliest enqueued (e.g., task P₁) in the run queue RQ₁ of the processor core CPU_1 (which is the heaviest-loaded processor core among the selected processor cores) to the run queue RQ₅ of the processor core CPU_5 (which is the processor core that triggers the load balance procedure, and is, for example, the idlest processor core), as shown in FIG. 9.

As mentioned above, during the load balance procedure, the proposed thread group aware task scheduling scheme may be enabled when task migration from one cluster to another cluster is needed (e.g., the busiest processor core (which may act as the target source of the task migration) and the processor core that triggers the load balance procedure (which may act as the target destination of the task migration) of the selected processor cores are included in different clusters) and a run queue of the target source of the task migration (e.g., the busiest processor core among the selected processor cores) includes at least one task belonging to a thread group having multiple tasks sharing same specific data and/or accessing same specific memory address(es). The proposed thread group aware task scheduling scheme may further check task distribution of the thread group in the clusters to determine if task migration should be performed upon a task belonging to the thread group and included in the run queue of the target source of the task migration (e.g., the busiest processor core). However, when finding that task migration from one cluster to another cluster is not needed (e.g., the busiest processor core and the processor core that triggers the load balance procedure are included in the same cluster) or a run queue of the target source of the task migration (e.g., the busiest processor core) includes no task belonging to a thread group having multiple tasks sharing same specific data and/or accessing same specific memory address(es), the scheduling unit 104 may enable another task scheduling scheme for load balance, without using the proposed thread group aware task scheduling scheme for improved cache locality.

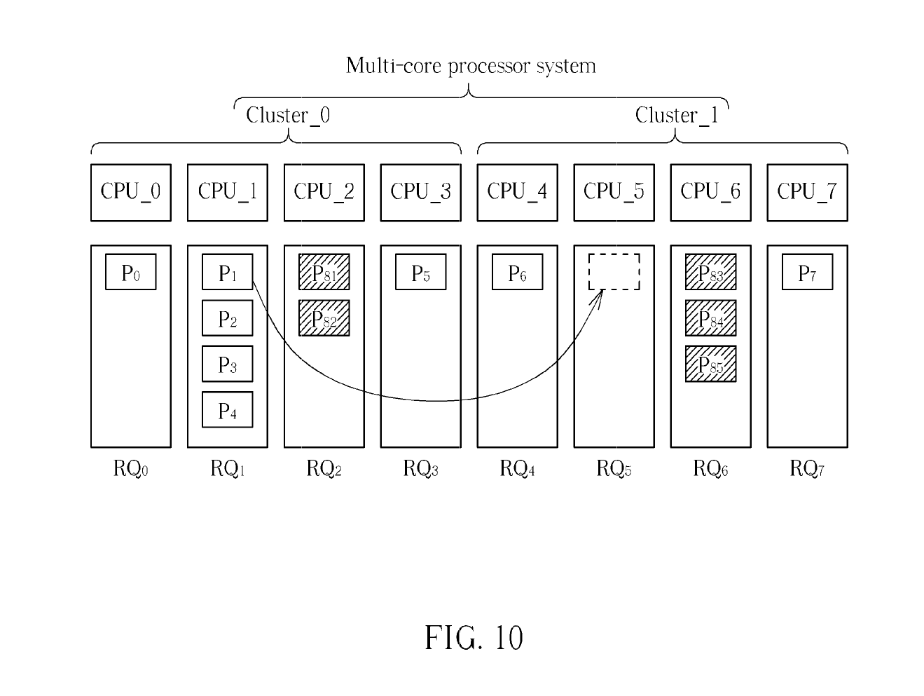

FIG. 10 is a diagram illustrating an eighth task scheduling operation which makes one task that is a single-threaded process migrate from a run queue of a processor core (e.g., a heaviest-loaded processor core) in one cluster to a run queue of a processor core (e.g., an idle processor core) in another cluster. Assume that the processor core CPU_5 triggers a load balance procedure due to an empty run queue or an expired timer. In this example, at the time the load balance procedure begins, the run queue RQ₀ may include one task P₀; the run queue RQ₁ may include four tasks P₁, P₂, P₃, and P₄; the run queue RQ₂ may include two tasks P₈₁ and P₈₂; the run queue RQ₃ may include one task P₅; the run queue RQ₄ may include one task P₆; the run queue RQ₆ may include three tasks P₈₃, P₈₄, and P₈₅; and the run queue RQ₇ may include one task P₇. Each of the tasks P₀-P₇ in some of the run queues RQ₀-RQ₇ may be a single-threaded process, and the tasks P₈₁-P₈₅ in some of the run queues RQ₀-RQ₇ may belong to the same thread group. In this example, the multi-core processor system 10 currently has one thread group having multiple tasks P₈₁-P₈₅ sharing same specific data and/or accessing same specific memory address(es).

When the load balance procedure begins, the scheduling unit 104 may compare processor core loads of the selected processor cores CPU_0-CPU_7 to find a target source of the task migration. In this example shown in FIG. 10, the processor core CPU_5 is an idle processor core with no running task and/or runnable task. However, this is for illustrative purposes only, and is not meant to be a limitation of the present invention. That is, a processor core that triggers a load balance procedure due to timer expiration may not necessarily be an idlest processor core (e.g., an idle processor core with no running task and/or runnable task, or a lightest-loaded processor core with non-zero processor core load (if there is no idle processor core)) among all selected processor cores. In this example, compared to the processor core CPU_5 (which is the processor core that triggers the load balance procedure), each of the processor cores CPU_0-CPU_4 and CPU_6-CPU_7 shown in FIG. 10 may have a heavier processor core and therefore may be regarded as one candidate source of the task migration.

By way of example, but not limitation, the scheduling unit 104 may be configured to find a busiest processor core (e.g., a heaviest-loaded processor core with non-zero processor core load) as the target source of the task migration. In this example, the busiest processor core among the selected processor cores CPU_0-CPU_7 may be the processor core CPU_1 in cluster Cluster_0. Further, the processor core CPU_5 (which is the processor core that triggers the load balance procedure) is part of the cluster Cluster_1 that has a larger number of tasks belonging to the same thread group. However, the run queue RQ₁ of the processor core CPU_1 (which is the busiest processor core among the selected processor cores) includes no task belonging to the thread group currently in the multi-core processor system 10. It should be noted that, with regard to the multi-core processor system performance, load balance may be more critical than cache coherence overhead reduction. Hence, the policy of achieving load balance may override the policy of improving cache locality. Though the number of tasks (e.g., P₈₃-P₈₅) that belong to a thread group and are included in the run queue RQ₆ of the processor core CPU_6 in the cluster Cluster_1 is larger than the number of tasks (e.g., P₈₁-P₈₂) that belong to the same thread group and are included in the run queue RQ₂ of the processor core CPU_2 in the cluster Cluster_0, none of the tasks P₈₁-P₈₅ is included in the run queue RQ₁ of the busiest processor core CPU_1. Since using the proposed thread group aware task scheduling scheme fails to meet the load balance requirement, the proposed thread group aware task scheduling scheme may not be enabled in this case. Hence, the task migration from one cluster to another cluster may be controlled without considering the thread group. By way of example, another task scheduling operation may be performed by the scheduling unit 104 to move a single-threaded process with that earliest enqueued (e.g., task P₁) in the run queue RQ₁ of the processor core CPU_1 (which is the busiest processor core among the selected processor cores) to the run queue RQ₅ of the processor core CPU_5 (which is the processor core that triggers the load balance procedure, and is, for example, an idlest processor core), as shown in FIG. 10.

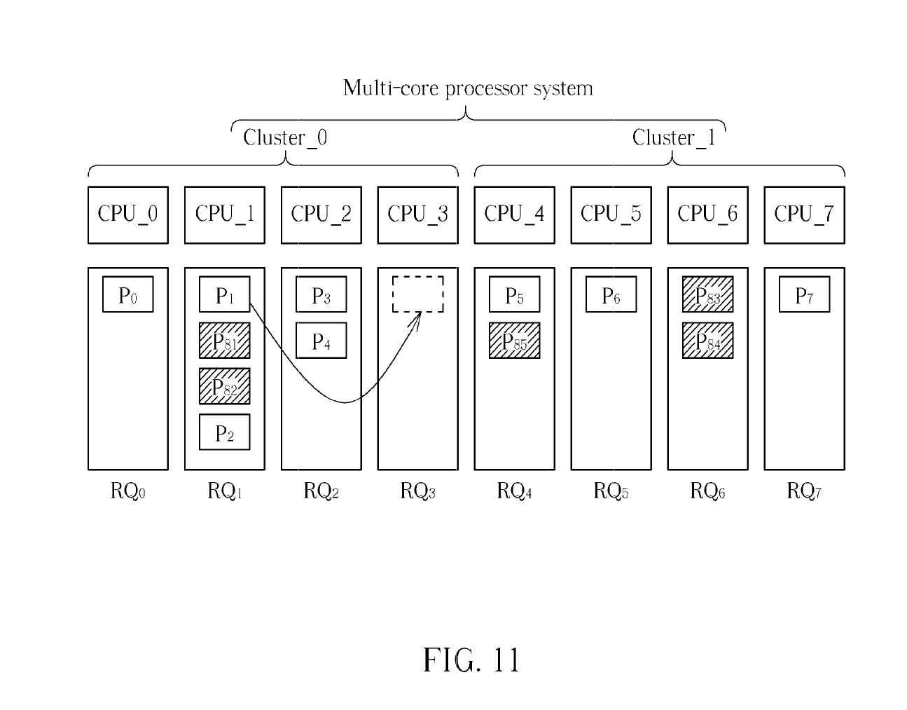

FIG. 11 is a diagram illustrating a ninth task scheduling operation which makes one task that is a single-threaded process migrate from a run queue of a processor core (e.g., a heaviest-loaded processor core) in a cluster to a run queue of a processor core (e.g., an idle processor core) in the same cluster. Assume that the processor core CPU_3 triggers a load balance procedure due to an empty run queue or an expired timer. In this example, at the time the load balance procedure begins, the run queue RQ₀ may include one task P₀; the run queue RQ₁ may include four tasks P₁, P₈₁, P₈₂, and P₂; the run queue RQ₂ may include two tasks P₃ and P₄; the run queue RQ₄ may include two tasks P₅ and P₈₅; the run queue RQ₅ may include one task P₆; the run queue RQ₆ may include two tasks P₈₃ and P₈₄; and the run queue RQ₇ may include one task P₇. Each of the tasks P₀-P₇ in some of the run queues RQ₀-RQ₇ may be a single-threaded process, and the tasks P₈₁-P₈₅ in some of the run queues RQ₀-RQ₇ may belong to the same thread group. In this example, the multi-core processor system 10 currently has one thread group having multiple tasks P₈₁-P₈₅ sharing same specific data and/or accessing same specific memory address(es).

When the load balance procedure begins, the scheduling unit 104 may compare processor core loads of the selected processor cores CPU_0-CPU_7 to find a target source of the task migration. In this example shown in FIG. 11, the processor core CPU_3 is an idle processor core with no running task and/or runnable task. However, this is for illustrative purposes only, and is not meant to be a limitation of the present invention. That is, a processor core that triggers a load balance procedure due to timer expiration may not necessarily be an idlest processor core (e.g., an idle processor core with no running task and/or runnable task, or a lightest-loaded processor core with non-zero processor core load (if there is no idle processor core)) among all selected processor cores. In this example, compared to the processor core CPU_3 (which is the processor core that triggers the load balance procedure), each of the processor cores CPU_0-CPU_2 and CPU_4-CPU_7 shown in FIG. 11 may have a heavier processor core and therefore may be regarded as one candidate source of the task migration.

By way of example, but not limitation, the scheduling unit 104 may be configured to find a busiest processor core (e.g., a heaviest-loaded processor core with non-zero processor core load) as the target source of the task migration. In this example, the busiest processor core may be the processor core CPU_1 in cluster Cluster_0. As mentioned above, the policy of achieving load balance may override the policy of improving cache locality. If the proposed thread group aware task scheduling scheme is performed, the scheduling unit 104 may control one task (e.g., P₈₁ or P₈₂) to migrate from the run queue RQ₁ of the processor core CPU_1 in the cluster Cluster_0 to a run queue of a processor core in the cluster Cluster_1 for improving cache locality. However, as can be known from FIG. 11, the processor core that triggers the load balance procedure (i.e., the processor core CPU_3) is part of the cluster Cluster_0 that has a smaller number of tasks belonging to the same thread group. Moving a task from the cluster Cluster_0 to the cluster Cluster_1 fails to achieve load balance requested by the processor core CPU_3 included in the cluster Cluster_0. Hence, though the number of tasks (e.g., P₈₃-P₈₅) that belong to a thread group and are included in run queues RQ₄, RQ₆ of processor cores CPU_4, CPU_6 in the cluster Cluster_1 is larger than the number of tasks (e.g., P₈₁-P₈₂) that belong to the same thread group and are included in the run queue RQ₁ of the processor core CPU_1 in the cluster Cluster_0, no task migration from one cluster to another cluster is needed. Since using the proposed thread group aware task scheduling scheme fails to meet the load balance requirement, the proposed thread group aware task scheduling scheme may not be enabled in this case. The task migration from one processor core to another processor core in the same cluster may be controlled without considering the thread group. By way of example, another task scheduling operation may be performed by the scheduling unit 104 to move a single-threaded process that is earliest enqueued (e.g., task P₁) in the run queue RQ₁ of the processor core CPU_1 (which is the heaviest-loaded processor core among the selected processor cores) to the run queue RQ₃ of the processor core CPU_3 (which is the processor core that triggers the load balance procedure, and is, for example, an idlest processor core), as shown in FIG. 11.

It should be noted that the examples shown in FIG. 3-FIG. 11 are for illustrative purposes only, and are not meant to be limitations of the present invention. In practice, the criteria of enabling the proposed thread group aware task scheduling scheme and enabling task migration based on distribution of tasks belonging to a thread group may be adjusted, depending upon actual design consideration. For example, the proposed thread group aware task scheduling scheme may collaborate with other task scheduling scheme(s) to achieve load balance as well as improved cache locality. For another example, the proposed thread group aware task scheduling scheme may be performed, regardless of load balance. To put it simply, any task scheduler design supporting at least the proposed thread group aware task scheduling scheme falls within the scope of the present invention.

In summary, a task scheduler may be configured to support a thread group aware task scheduling scheme proposed by the present invention. Hence, when the thread group aware task scheduling scheme is employed to decide how to dispatch a task of a thread group, the cache coherence overhead is considered. In this way, when the task of the thread group is a new or resumed task, the task of the thread group may be dispatched to a cluster which has an idlest processor core (e.g., an idle processor core with no running task and/or runnable task, or a lightest-loaded processor core with non-zero processor core load (if there is no idle processor core)) and has most tasks in the same thread group. Further, when the task of the thread group is a task already in a run queue, the task of the thread group may be dispatched to a cluster which has a processor core that triggers a load balance procedure and has most tasks in the same thread group. Thus, the cache coherence overhead can be mitigated or avoided due to improved cache locality.

Those skilled in the art will readily observe that numerous modifications and alterations of the device and method may be made while retaining the teachings of the invention. Accordingly, the above disclosure should be construed as limited only by the metes and bounds of the appended claims.

1. A task scheduling method for a multi-core processor system, comprising:
when a first task belongs to a thread group currently in the multi-core processor system, where the thread group has a plurality of tasks sharing same specific data, and the tasks comprise the first task and at least one second task,
determining a target processor core in the multi-core processor system based at least partly on distribution of the at least one second task in at least one run queue of at least one processor core in the multi-core processor system; and
dispatching the first task to a run queue of the target processor core.

2. The task scheduling method of claim 1, wherein the multi-core processor system comprises a plurality of clusters, each having one or more processor cores; the target processor core is included in a target cluster of the clusters; and among the clusters, the target cluster has a largest number of tasks belonging to the thread group and included in at least one run queue of at least one selected processor core in the multi-core processor system.

3. The task scheduling method of claim 2, wherein the first task that is to be dispatched is not included in run queues of the multi-core processor system.

4. The task scheduling method of claim 2, wherein the clusters include a first cluster, having at least one lightest-loaded processor core with non-zero processor core load among at least one selected processor core in the multi-core processor system; and the first cluster is the target cluster.

5. The task scheduling method of claim 4, wherein the target processor core is one lightest-loaded processor core of the target cluster.

6. The task scheduling method of claim 2, wherein the clusters include a first cluster, having at least one idle processor core with no running task and/or runnable task among at least one selected processor core in the multi-core processor system; and the first cluster is the target cluster.

7. The task scheduling method of claim 6, wherein the target processor core is one idle processor core of the target cluster.

8. The task scheduling method of claim 2, wherein the first task that is to be dispatched is included in a specific run queue of run queues of selected processor cores in the multi-core processor system.

9. The task scheduling method of claim 8, wherein the specific run queue is possessed by a specific processor core of the selected processor cores, and a processor core load of the specific processor core is heavier than a processor core load of the target processor core that triggers a load balance procedure.

10. The task scheduling method of claim 9, wherein the target cluster is different from a cluster having the specific processor core.

11. A task scheduling method for a multi-core processor system, comprising:
when a first task belongs to a thread group currently in the multi-core processor system, where the thread group has a plurality of tasks accessing same specific memory address(es), and the tasks comprise the first task and at least one second task,
determining a target processor core in the multi-core processor system based at least partly on distribution of the at least one second task in at least one run queue of at least one processor core in the multi-core processor system; and
dispatching the first task to a run queue of the target processor core.

12. The task scheduling method of claim 11, wherein the multi-core processor system comprises a plurality of clusters, each having one or more processor cores; the target processor core is included in a target cluster of the clusters; and among the clusters, the target cluster has a largest number of tasks belonging to the thread group and included in at least one run queue of at least one selected processor core in the multi-core processor system.

13. The task scheduling method of claim 12, wherein the first task that is to be dispatched is not included in run queues of the multi-core processor system.

14. The task scheduling method of claim 12 wherein the clusters include a first cluster, having at least one lightest-loaded processor core with non-zero processor core load among at least one selected processor core in the multi-core processor system; and the first cluster is the target cluster.

15. The task scheduling method of claim 14, wherein the target processor core is one lightest-loaded processor core of the target cluster.

16. The task scheduling method of claim 12, wherein the clusters include a first cluster, having at least one idle processor core with no running task and/or runnable task among at least one selected processor core in the multi-core processor system; and the first cluster is the target cluster.

17. The task scheduling method of claim 16, wherein the target processor core is one idle processor core of the target cluster.

18. The task scheduling method of claim 12, wherein the first task that is to be dispatched is included in a specific run queue of run queues of selected processor cores in the multi-core processor system.

19. The task scheduling method of claim 18, wherein the specific run queue is possessed by a specific processor core of the selected processor cores, and a processor core load of the specific processor core is heavier than a processor core load of the target processor core that triggers a load balance procedure.

20. The task scheduling method of claim 19, wherein the target cluster is different from a cluster having the specific processor core.

21. A non-transitory computer readable medium storing a program code that, when executed by a multi-core processor system, causes the multi-core processor system to perform the method of claim 1.

22. A non-transitory computer readable medium storing a program code that, when executed by a multi-core processor system, causes the multi-core processor system to perform the method of claim 11.
